(19) United States
(12) Patent Application Publication
(10) Pub. No.: US 2025/0237983 A1
(43) Pub. Date: Jul. 24, 2025

(54) IMAGE FORMING APPARATUS

(71) Applicant: CANON KABUSHIKI KAISHA, Tokyo (JP)

(72) Inventors: SUMITO TANAKA, Tokyo (JP); MIREI AOYAMA, Chiba (JP)

(21) Appl. No.: 19/028,553

(22) Filed: Jan. 17, 2025

(30) Foreign Application Priority Data
Jan. 18, 2024 (JP) 2024-006350
Nov. 1, 2024 (JP) 2024-192996

(51) Int. Cl. G03G 15/00

(52) U.S. Cl. CPC G03G 15/5041; G03G 2215/00042; G03G 2215/00063; G03G 2215/00067

(57) ABSTRACT

Disclosed is an image forming apparatus for forming an image on a sheet, the image forming apparatus including an image forming unit configured to form an image on a photosensitive member with the photosensitive member rotating, and transfer the image formed on the photosensitive member onto the sheet to form the image on the sheet, a reading unit configured to read a measurement image formed on the sheet by the image forming unit, the measurement image including a first detection image for detecting density at positions different in an axial direction of a rotation axis of the photosensitive member of an image to be formed on the photosensitive member; and a second detection image for detecting density at positions different in a rotation direction of the photosensitive member of an image to be formed on the photosensitive member.

### BACKGROUND OF THE INVENTION

### Field of the Invention

The present disclosure relates to image density unevenness correction for suppressing density unevenness of an image formed on a sheet.

### Description of the Related Art

For example, an image forming apparatus employing an electrophotographic system performs image formation by scanning a photosensitive drum with laser light. The photosensitive drum is a drum-shaped photosensitive member including a photosensitive layer on its surface. The image forming apparatus uniformly charges the photosensitive layer of the photosensitive drum, and then irradiates (scans) the photosensitive layer with laser light, to thereby form an electrostatic latent image on the photosensitive layer of the photosensitive drum. The electrostatic latent image is developed by toner to become a toner image, and the toner image is transferred onto a sheet. For example, heat and pressure are applied to the sheet having the toner image transferred thereon so that the toner image melts to be fixed. An image is formed (printed) on the sheet as described above.

Such an image forming apparatus has a possibility of occurrence of charging unevenness at the time of charging the photosensitive drum, exposure unevenness at the time of scanning, development unevenness at the time of development, and the like. Those kinds of unevenness may cause occurrence of image density unevenness in a predetermined direction of an image formed on the sheet. For example, the image density unevenness occurs in a main scanning direction and a sub-scanning direction. The main scanning direction is a direction in which the laser light scans the photosensitive drum, and corresponds to a drum shaft direction (an axial direction of a rotation axis of the photosensitive drum). The sub-scanning direction is a direction intersecting with the main scanning direction, and corresponds to a rotation direction of the photosensitive drum.

In order to correct image density unevenness in a predetermined direction, an image forming range is divided into a plurality of regions in a predetermined direction, and an image density is controlled in each region. In order to detect the image density unevenness in the predetermined direction, a sheet on which a test image for detecting the image density of each region is formed is used. An amount of laser light is adjusted based on a measurement result of the test image for each region so that there is no image density difference between the regions, to thereby correct the image density unevenness. For example, in U.S. Pat. No. 10,948,864, there is disclosed a technology for correcting image density unevenness in a main scanning direction. In each of Japanese Patent Application Laid-open No. 2000-98675 and Japanese Patent Application Laid-open No. 2022-71704, there is disclosed a technology for correcting image density unevenness in a sub-scanning direction.

In U.S. Pat. No. 10,948,864, the image density unevenness in the main scanning direction is corrected based on measurement results of a plurality of test images arranged in the main scanning direction. In Japanese Patent Application Laid-open No. 2000-98675, the image density unevenness in the sub-scanning direction that occurs in a rotation cycle of a developing sleeve is corrected based on detection results of a toner image formed on a photosensitive belt. The developing sleeve is a member that is rotated in accordance with rotation of a photosensitive drum to cause toner to adhere to an electrostatic latent image. In Japanese Patent Application Laid-open No. 2022-71704, the image density unevenness in the sub-scanning direction is corrected based on a measurement result of a test pattern in which the sub-scanning direction is a longitudinal direction.

As described above, the image density unevenness in the main scanning direction and the image density unevenness in the sub-scanning direction are respectively corrected by separate and independent types of correction control. In this case, a correction target of the image density unevenness in the main scanning direction and a correction target of the image density unevenness in the sub-scanning direction may differ from each other. Therefore, it is difficult to correct the image density unevenness over the entire surface of the sheet with high accuracy. Specifically, the image density serving as the correction target in the main scanning direction is set to an average image density in the main scanning direction, and the image density serving as the correction target in the sub-scanning direction is set to an average image density in the sub-scanning direction, thereby causing the average image density to differ depending on the direction and thus lowering correction accuracy. The same applies to even a case of using a minimum image density is used in place of the average image density.

### SUMMARY OF THE INVENTION

An image forming apparatus for forming an image on a sheet according to one embodiment of the present disclosure includes an image forming unit configured to form an image on a photosensitive member with the photosensitive member rotating, and transfer the image formed on the photosensitive member onto the sheet to form the image on the sheet, a reading unit configured to read a measurement image formed on the sheet by the image forming unit, the measurement image including, a first detection image for detecting density at positions different in an axial direction of a rotation axis of the photosensitive member of an image to be formed on the photosensitive member, and a second detection image for detecting density at positions different in a rotation direction of the photosensitive member of an image to be formed on the photosensitive member, and a controller configured to: determine target data based on reading results of the first detection image read by the reading unit and reading results of the second detection image read by the reading unit, and suppress the density unevenness of the image to be formed on the photosensitive member in the rotation direction of the photosensitive member, based on the reading results of the first detection image read by the reading unit, the reading results of the second detection image read by the reading unit, and the target data.

An image forming apparatus for forming an image on a sheet according to according to another embodiment of the present disclosure includes an image forming apparatus for forming an image on a sheet, the image forming apparatus including an image forming unit configured to form an image on a photosensitive member with the photosensitive member rotating, and transfer the image formed on the photosensitive member onto the sheet, a reading unit configured to read a measurement image formed on the sheet by the image forming unit, the measurement image including, a first detection image for detecting densities of images at different positions in an axial direction of a rotation axis of the photosensitive member, and a second detection image for detecting densities of images at different positions in a rotation direction of the photosensitive member, and a controller configured to, determine target data based on reading results of the first detection image read by the reading unit and reading results of the second detection image read by the reading unit, and suppress the density unevenness of the image to be formed on the photosensitive member in the axial direction, based on the reading results of the first detection image read by the reading unit, the reading results of the second detection image read by the reading unit, and the target data.

An image forming apparatus for forming an image on a sheet according to yet another embodiment of the present disclosure includes an image forming unit configured to form an image of a first color on a first photosensitive member with the first photosensitive member rotating, a reading unit configured to read a plurality of measurement images on the sheet which have been formed by the image forming unit, the plurality of measurement images including, a first measurement image for detecting density at positions different in a rotation direction of an image to be formed on the first photosensitive member, and a second measurement image for detecting density at positions different in the rotation direction of an image to be formed on the first photosensitive member, wherein the sheet on which the plurality of measurement images are formed has a region where an image of the first color is not formed between the first measurement image and the second measurement image in an axial direction of a rotation axis of the first photosensitive member, and a controller, determine target data based on reading results of the first measurement image read by the reading unit and reading results of the second measurement image read by the reading unit, and suppress density unevenness of an image of the first color to be formed on the first photosensitive member in the rotation direction of the first photosensitive member, based on the reading results of the first measurement image read by the reading unit, the reading results of the second measurement image read by the reading unit, and the target data.

Further features of the present invention will become apparent from the following description of exemplary embodiments (with reference to the attached drawings).

### BRIEF DESCRIPTION OF THE DRAWINGS

FIG. 1 is an explanatory diagram of a configuration of an image forming apparatus according to a first embodiment of the present disclosure.

FIG. 2 is a functional block diagram of the image forming apparatus.

FIG. 3 is an exemplary diagram of a configuration of a printer image processor.

FIG. 4 is an explanatory diagram of a processor for image data.

FIG. 5 is a configuration view of image forming portions of a printer engine.

FIG. 6 is a flow chart for illustrating image density unevenness correction processing in the first embodiment.

FIG. 7 is an explanatory view of main scanning measurement images.

FIG. 8 is an explanatory view of sub-scanning measurement images.

FIG. 9 is an explanatory table for showing image densities in a main scanning direction after the image density unevenness correction.

FIG. 10 is an explanatory table for showing image densities in a sub-scanning direction after the image density unevenness correction.

FIG. 11 is an explanatory table for showing image densities in the main scanning direction after the image density unevenness correction.

FIG. 12 is an explanatory table for showing image densities in the sub-scanning direction after the image density unevenness correction.

FIG. 13 is a flow chart for illustrating image density unevenness correction processing in a second embodiment of the present disclosure.

FIG. 14 is a flow chart for illustrating image density unevenness correction processing in a fourth embodiment of the present disclosure.

FIG. 15 is another schematic view of the sub-scanning measurement images.

FIG. 16 is another schematic view of the main scanning measurement images.

### DESCRIPTION OF THE EMBODIMENTS

Now, preferred embodiments of the present disclosure are described with reference to the attached drawings. In the following description, like components are denoted by like reference symbols.

### First Embodiment

In a first embodiment of the present disclosure, as an example, a laser beam printer employing an electrophotographic system is described as an image forming apparatus. However, the image forming apparatus is not limited to the laser beam printer, and may be a printer other than the laser beam printer, such as a light emitting diode (LED) printer, as long as the electrophotographic system is employed.

### Configuration of Image Forming Apparatus

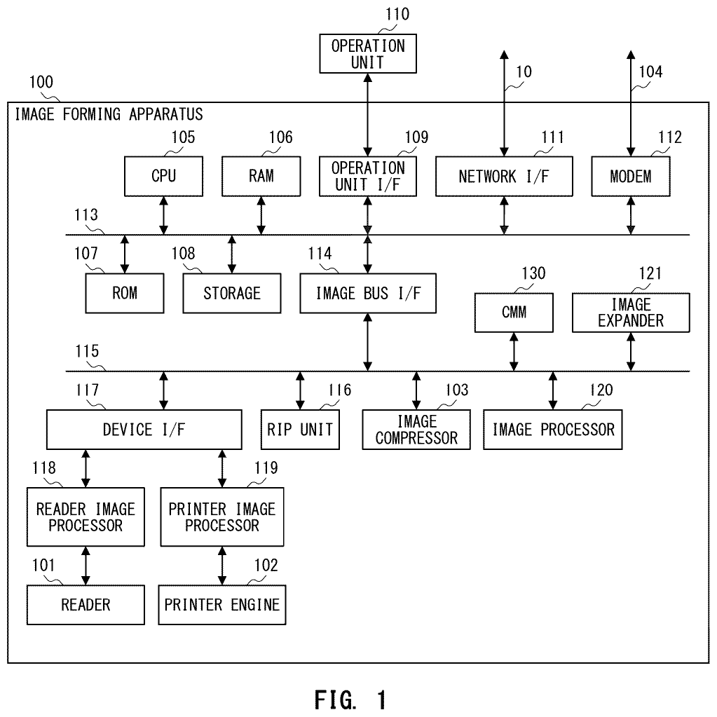

FIG. 1 is an explanatory diagram of a configuration of an image forming apparatus according to the first embodiment. In an image forming apparatus 100, a reader 101, which is an image input device, and a printer engine 102, which is an image output device, are internally connected to each other.

The reader 101 is connected to a device interface (I/F) 117 through a reader image processor 118. The printer engine 102 is connected to the device I/F 117 through a printer image processor 119. The reader image processor 118 performs control for image reading using the reader 101. The reader 101 is an optical reading machine that optically reads an image by, for example, irradiating the image with light and receiving light reflected therefrom. The printer image processor 119 performs control for printing an image on a sheet through use of the printer engine 102.

The image forming apparatus 100 is connected to a network 10, such as a local area network (LAN), and a public line 104, and can transmit and receive image information and apparatus information described later through the network 10 and the public line 104. To that end, the image forming apparatus 100 includes a network I/F 111 and a modem 112. The network I/F 111 is implemented by, for example, a network interface card (NIC), and controls communication to/from an external device (not shown) through the network 10. The modem 112 controls communication to/from an external device (not shown) through the public line 104.

An operation unit 110 is connected to the image forming apparatus 100. To that end, the image forming apparatus 100 is provided with an operation unit I/F 109. The operation unit 110 is a user interface including an input interface and an output interface. The input interface is, for example, various key buttons or a touch panel. The output interface is, for example, a display or a speaker. The image forming apparatus 100 acquires instructions, settings, and the like input from the operation unit 110 through the operation unit I/F 109. The image forming apparatus 100 displays a screen such as a setting screen on the operation unit 110 and outputs sound thereto through the operation unit I/F 109.

The image forming apparatus 100 includes a central processing unit (CPU) 105, a random access memory (RAM) 106, a read only memory (ROM) 107, and a storage 108. The CPU 105 executes a startup program stored in the ROM 107, and executes a computer program such as software stored in the storage 108 to control the operation of the image forming apparatus 100. The RAM 106 functions as a work memory to be used in a case where the CPU 105 executes processing. The RAM 106 also includes a storage area for temporarily storing data such as image data. The storage 108 is a large-capacity storage device such as a hard disk drive (HDD) or a solid state drive (SSD).

The CPU 105, the RAM 106, the ROM 107, the storage 108, the operation unit I/F 109, the network I/F 111, and the modem 112 are connected to a system bus 113, and can communicate to/from each other. An image bus I/F 114 is also connected to the system bus 113. The image bus I/F 114 is an interface for connecting the system bus 113 to an image bus 115 for transferring image data at high speed, and is a bus bridge for converting a data structure between the system bus 113 and the image bus 115. The image bus I/F 114 enables communication between each component connected to the system bus 113 and each component connected to the image bus 115.

A raster image processor (RIP) unit 116, the above-mentioned device I/F 117, an image processor 120 for image editing, an image compressor 103, an image expander 121, and a color management module (CMM) 130 are connected to the image bus 115.

The RIP unit 116 develops page description language (PDL) data into image data. The device I/F 117 is connected to the reader 101 through the reader image processor 118, and is connected to the printer engine 102 through the printer image processor 119. The device I/F 117 converts image data in a synchronous manner or an asynchronous manner. The reader image processor 118 performs various types of processing such as correction and editing on image data that is a result of reading an image acquired from the reader 101. The printer image processor 119 performs image processing such as γ correction and halftone processing corresponding to the printer engine 102 on image data representing an image to be printed on a sheet.

The image processor 120 for image editing performs various types of image processing such as rotation, color processing, binary conversion, and multi-value conversion of the image data. The image compressor 103 encodes the image data processed by the RIP unit 116, the reader image processor 118, and the image processor 120 for image editing through use of a predetermined compression method in a case where temporarily storing the image data in the storage 108. The image expander 121 decodes and expands the image data compressed and stored in the storage 108 in a case where the image data is used for processing by the image processor 120 for image editing or in a case where the image is subjected to image processing by the printer image processor 119 to be output by the printer engine 102.

The CMM 130 is a dedicated hardware module that performs color conversion processing (also referred to as “color space conversion processing”) based on a profile and calibration data on the image data. The profile refers to a function or other such information for converting color image data expressed by a color space dependent on the apparatus into a color space (for example, Lab color space) independent of the apparatus. The calibration data is data for correcting the color reproducibility of the reader 101 or the printer engine 102.

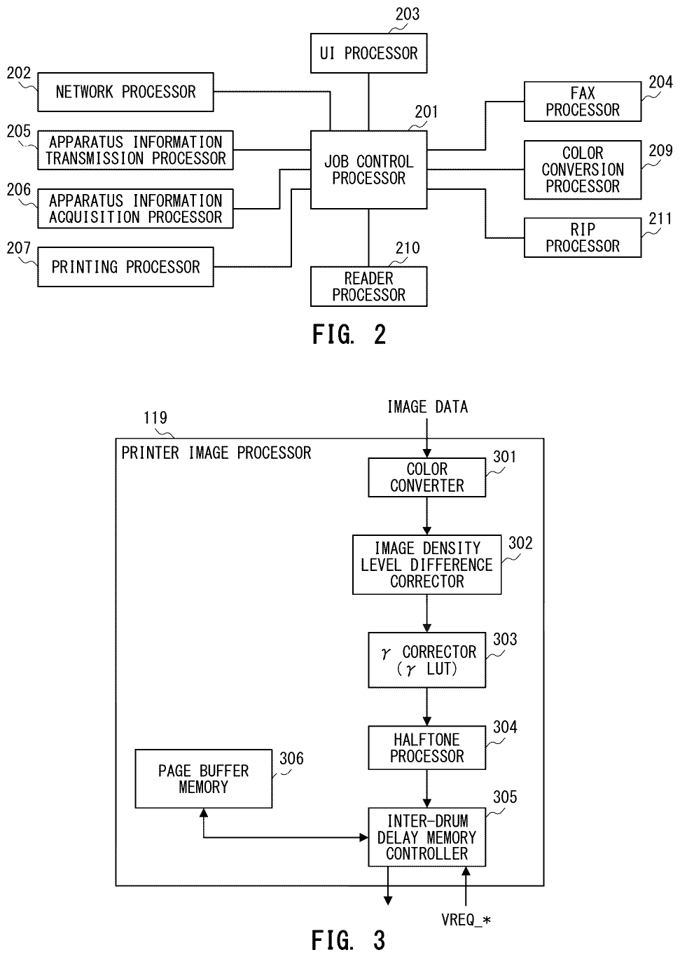

FIG. 2 is a functional block diagram of the image forming apparatus 100. Each functional block is implemented by the CPU 105 executing the computer program. The image forming apparatus 100 functions as a job control processor 201 for controlling various functions that can be implemented by the image forming apparatus 100. The image forming apparatus 100 functions as a network processor 202, a UI processor 203, a FAX processor 204, an apparatus information transmission processor 205, an apparatus information acquisition processor 206, a printing processor 207, a color conversion processor 209, a reader processor 210, and a RIP processor 211.

The network processor 202 controls communication to/from an external device through the network I/F 111. The UI processor 203 controls the operation unit 110 and the operation unit I/F 109. The FAX processor 204 controls a facsimile function. The FAX processor 204 controls facsimile communication through the modem 112.

The apparatus information transmission processor 205 transmits apparatus information to a predetermined external device by the network processor 202 based on an instruction from the job control processor 201. The apparatus information to be transmitted includes information indicating the abilities and the characteristics of the image forming apparatus 100. For example, the apparatus information includes the type (color/monochrome) of the printer engine 102, the resolution of the printer engine 102, the printing speed of the printer engine 102, the processing time of the color conversion processor 209, and the output profile. The apparatus information acquisition processor 206 transmits an apparatus information acquisition request to a predetermined external apparatus by the network processor 202 based on the instruction from the job control processor 201.

The printing processor 207 controls the image processor 120 for image editing, the printer image processor 119, and the printer engine 102 based on the instruction from the job control processor 201 to perform processing for printing an image on a sheet. The printing processor 207 acquires, from the job control processor 201, information such as image data, image information (for example, image data size, color mode, and resolution), layout information (for example, offset, scaling, and imposition), and output sheet information (for example, size and printing direction). The printing processor 207 controls the image compressor 103, the image expander 121, the image processor 120 for image editing, and the printer image processor 119 to subject the image data to appropriate image processing. The printing processor 207 controls the printer engine 102 to print an image on the designated sheet based on the image data that has been subjected to the image processing.

The reader processor 210 controls the reader 101 and the reader image processor 118 based on an instruction from the job control processor 201 to cause the reader 101 to read an image printed on a sheet. The reader processor 210 scans the sheet placed on a platen by the reader 101, and acquires the read image (read data) of the image printed on the sheet as digital data from the reader 101. The reader processor 210 notifies the job control processor 201 of color information on the acquired read data. The reader processor 210 controls the reader image processor 118 to subject the read data to appropriate image processing such as image compression, and then transmits the read image that has been subjected to the image processing to the job control processor 201.

The color conversion processor 209 performs color conversion processing on the designated image based on an instruction from the job control processor 201, and notifies the job control processor 201 of the image that has been subjected to the color conversion processing. The RIP processor 211 performs PDL interpretation (interprets) based on an instruction from the job control processor 201, and controls the RIP unit 116 to perform rendering, to thereby develop the image data into a bitmap image.

### Image Data Processing

The image forming apparatus 100 having the configuration described above receives a print job from an external device through the network 10, and prints an image corresponding to the print job on a sheet. The print job includes PDL data representing an image to be printed.

The print job is received by the network I/F 111 and transmitted to the RIP unit 116. The RIP unit 116 interprets the PDL data included in the acquired print job to convert the PDL data into code data processable by the RIP unit 116. The RIP unit 116 executes rendering based on the code data obtained by conversion to generate image data. The PDL data rendered by the RIP unit 116 is compressed as image data by the image compressor 103 in the subsequent stage, and is sequentially stored in the storage 108.

The compressed image data stored in the storage 108 is read out in a printing operation performed in accordance with an instruction from the job control processor 201, and is subjected to expansion processing performed by the image expander 121. The image data expanded by the image expander 121 is transmitted to the printer image processor 119 via the device I/F 117.

FIG. 3 is an exemplary diagram of a configuration of the printer image processor 119. The printer image processor 119 includes a color converter 301, an image density level difference corrector 302, a γ corrector 303, a halftone processor 304, an inter-drum delay memory controller 305, and a page buffer memory 306.

The color converter 301 converts the acquired image data into a color space corresponding to color components that can be printed by the printer engine 102 in the subsequent stage. To that end, the color converter 301 converts the image data from a brightness value (for example, RGB value or YUV value) to a density value (for example, CMYK value).

The image density level difference corrector 302 converts the multivalued image data, which has been obtained by the conversion into the density value by the color converter 301, into a density signal obtained by performing level difference correction of an image density within the same page. The image density level difference corrector 302, as well as the γ corrector 303 in the subsequent stage, includes a one-dimensional table for changing input and output signals. The one-dimensional table has a level difference correction coefficient for level difference correction in accordance with each position within a page. The image density level difference corrector 302 corrects the image data by multiplying the image data by the level difference correction coefficient.

The γ corrector 303 includes a γ look-up table (γLUT). The γ corrector 303 performs γ correction through use of the γLUT, and converts the density signal of the image data corrected by the image density level difference corrector 302 into a signal value for reproducing the image density by the printer engine 102. The γLUT is a table for converting input and output signals created in accordance with the γ characteristics of the printer engine 102. In the first embodiment, the γLUT is stored in advance, but may be created through use of known tone control or the like.

The halftone processor 304 subjects the image data corrected by the γ corrector 303 to halftone processing to convert the image data into image data in which each color component of one pixel is represented by a binary value (1 bit). Examples of the halftone processing that is generally used include dithering and error diffusion. In the first embodiment, the halftone processing may be performed by any one of those methods. The halftone processing is not limited to those methods, and may be performed by another method. The binary image data generated by the halftone processor 304 is divided for each color component of each pixel in the image data through the inter-drum delay memory controller 305, and temporarily stored in the page buffer memory 306.

At a timing at which the inter-drum delay memory controller 305 acquires a video data request signal (VREQ_* (where * represents Y, M, C, or K)) corresponding to each color component from the printer engine 102, the inter-drum delay memory controller 305 reads out the image data of the corresponding color component from the page buffer memory 306. The inter-drum delay memory controller 305 transmits the read-out image data to the printer engine 102.

The video data request signals are represented as VREQ_Y, VREQ_M, VREQ_C, and VREQ_K corresponding to the respective color components. Timings to expose photosensitive drums 1401 to 1404 corresponding to the respective color components in the printer engine 102, which are described later, during image formation differ from one another. For that reason, the printer engine 102 transmits the video data request signal for each color component at a different timing, and acquires the image data of each color component at a different timing as well. The printer engine 102 forms an image based on the acquired image data of each color component.

### Operation of Printer Engine

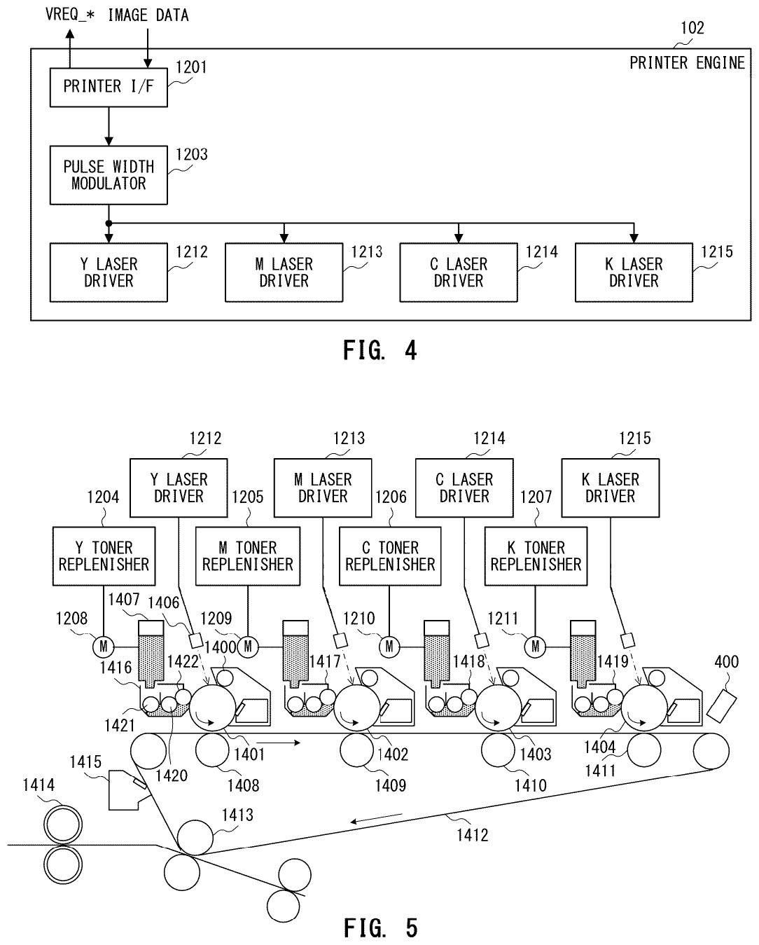

FIG. 4 is an explanatory diagram of a processor for image data provided in the printer engine 102. The printer engine 102 includes, as processors, a printer I/F 1201, a pulse width modulator 1203, a Y laser driver 1212, an M laser driver 1213, a C laser driver 1214, and a K laser driver 1215.

When the printer engine 102 becomes ready to perform a printing operation, the printer I/F 1201 transmits a video data request signal (VREQ_*) for requesting the image data of each color component to the printer image processor 119. The printer I/F 1201 receives the image data of each color component sequentially transmitted from the printer image processor 119. The image data of each color component received by the printer I/F 1201 is sent to the pulse width modulator 1203.

The pulse width modulator 1203 generates pulse signals (drive signals) for driving the Y laser driver 1212, the M laser driver 1213, the C laser driver 1214, and the K laser driver 1215 based on the acquired image data of the respective components. The drive signal is generated for each color. The generated drive signals are transmitted to the Y laser driver 1212, the M laser driver 1213, the C laser driver 1214, and the K laser driver 1215 for forming images of the respectively corresponding colors.

The Y laser driver 1212, the M laser driver 1213, the C laser driver 1214, and the K laser driver 1215 perform output control of laser light of the corresponding color component based on the acquired drive signal. The Y laser driver 1212 acquires the drive signal based on yellow image data to perform the output control of the laser light for forming a yellow image. The M laser driver 1213 acquires the drive signal based on magenta image data to perform the output control of the laser light for forming a magenta image. The C laser driver 1214 acquires the drive signal based on cyan image data to perform the output control of the laser light for forming a cyan image. The K laser driver 1215 acquires the drive signal based on black image data to perform the output control of the laser light for forming a black image.

FIG. 5 is a configuration view of image forming portions of the printer engine 102. As described above, the printer engine 102 of the image forming apparatus 100 according to the first embodiment adopts the electrophotographic system. The printer engine 102 of this type includes, for example, a photosensitive member, a charge unit that charges the photosensitive member, an exposure unit that exposes the charged photosensitive member, a developing unit that develops an electrostatic latent image formed on the photosensitive member by exposure, and a transfer unit that transfers a developed developer image onto an image bearing member. The printer engine 102 in the first embodiment is provided with toner of a plurality of color components (in this case, yellow (Y), magenta (M), cyan (C), and black (K)) as developer, and can form toner images of the plurality of color components on the image bearing member as developer images. The following description is mainly directed to the image forming portion of yellow, but the image forming portions of the other color components have the same configuration. The printer engine 102 in the first embodiment has a configuration using a tandem engine formed of four colors, that is, yellow (Y), magenta (M), cyan (C), and black (K), but the present disclosure is not limited thereto.

The printer engine 102 includes a photosensitive drum 1401, a charge roller 1400, a Y laser exposure device 1406, and a developing device 1416 as components for forming a yellow image. The printer engine 102 also includes a primary transfer unit 1408, an intermediate transfer belt 1412, a secondary transfer unit 1413, a fixing device 1414, and a cleaner 1415.

The photosensitive drum 1401 is a drum-shaped photosensitive body having a photosensitive layer on a surface thereof, and is rotatable in the arrow direction about a drum shaft. The photosensitive drum 1401 has a drum diameter of, for example, 32 mm. The charge roller 1400 is a charging member that uniformly charges the surface of the photosensitive drum 1401. The charge roller 1400 is drum-shaped, and has a drum diameter of, for example, 10 mm. The charge roller 1400 has a predetermined charging bias voltage applied thereto, to thereby uniformly charge the surface of the photosensitive drum 1401.

The Y laser exposure device 1406 (light source) is driven by the Y laser driver 1212. The Y laser exposure device 1406 irradiates the uniformly charged surface of the photosensitive drum 1401 with laser light modulated based on the drive signal for yellow, to thereby form an electrostatic latent image on the surface of the photosensitive drum 1401. The laser light scans the surface of the rotating photosensitive drum 1401 in a drum shaft direction. Thus, an electrostatic latent image is formed assuming that the drum shaft direction of the photosensitive drum 1401 is a main scanning direction and a rotation direction of the photosensitive drum 1401 is a sub-scanning direction.

The developing device 1416 develops the electrostatic latent image by the developer (in this case, toner). Through development of the electrostatic latent image, a yellow toner image is formed on the surface of the photosensitive drum 1401. In the same manner, a magenta toner image is formed on the surface of the photosensitive drum 1402. A cyan toner image is formed on the surface of the photosensitive drum 1403. A black toner image is formed on the surface of the photosensitive drum 1404.

The developing device 1416 in the first embodiment includes a developer container, and accommodates two-component developer in which toner particles (toner) and magnetic carrier particles (carrier) are mixed. The developer container is divided into two chambers, one of which is provided with an A screw 1420 and the other of which is provided with a B screw 1421. The A screw 1420 and the B screw 1421 convey and mix the toner particles and the magnetic carrier particles, respectively.

A developing sleeve 1422 is provided on the photosensitive drum 1401 side of the A screw 1420. The developing sleeve 1422 has a drum shape having a drum diameter of, for example, 13 mm. The developing sleeve 1422 is arranged close to the photosensitive drum 1401, and is rotated in accordance with the photosensitive drum 1401. The developing sleeve 1422 carries the developer in which toner and the carrier are mixed. When a developing bias voltage is applied to the developing sleeve 1422, the developer carried by the developing sleeve 1422 develops the electrostatic latent image on the photosensitive drum 1401.

When a transfer bias voltage is applied, the primary transfer unit 1408 transfers the yellow toner image on the photosensitive drum 1401 onto the intermediate transfer belt 1412, which is an image bearing member. When a transfer bias voltage is applied, the primary transfer unit 1409 transfers the magenta toner image on the photosensitive drum 1402 onto the intermediate transfer belt 1412. When a transfer bias voltage is applied, the primary transfer unit 1410 transfers the cyan toner image on the photosensitive drum 1403 onto the intermediate transfer belt 1412. When a transfer bias voltage is applied, the primary transfer unit 1411 transfers the black toner image on the photosensitive drum 1404 onto the intermediate transfer belt 1412.

The intermediate transfer belt 1412 is an endless belt-like transfer member that rotates in the arrow direction. The toner images of the respective colors are transferred at timings corresponding to a rotation speed of the intermediate transfer belt 1412 and intervals between the photosensitive drums 1401, 1402, 1403, and 1404, to thereby be borne on the intermediate transfer belt 1412 in a superimposed manner.

In accordance with the rotation of the intermediate transfer belt 1412, the toner images of the respective colors are conveyed to the secondary transfer unit 1413. A sheet is fed to the secondary transfer unit 1413 by a feeding mechanism (not shown) in accordance with a timing at which the toner images are conveyed thereto. When a transfer bias voltage is applied, the secondary transfer unit 1413 collectively transfers the toner images of the respective colors borne on the intermediate transfer belt 1412 onto the sheet. The sheet onto which the toner images have been transferred is conveyed to the fixing device 1414. The toner remaining on the intermediate transfer belt 1412 after the transfer is removed by the cleaner 1415.

The fixing device 1414 fixes the toner images transferred onto the sheet to the sheet. For example, the fixing device 1414 heats the sheet bearing the toner images thereon and applies pressure thereto, to thereby melt and fix the toner image to the sheet. In this manner, an image is printed on the sheet. The sheet is also an example of the image bearing member that bears an image thereon.

An image density sensor 400 is arranged on a downstream side of the photosensitive drum 1404 that is used for forming a black image in a rotation direction of the intermediate transfer belt 1412. The image density sensor 400 is an optical sensor to be used to measure the image density of the toner images borne on the intermediate transfer belt 1412.

A toner bottle 1407 for replenishing the developing device 1416 with toner is attached to the developing device 1416 that is used for forming a yellow image. The toner bottle 1407 is driven to rotate by a motor 1208, to thereby supply yellow toner to the developing device 1416. An operation of the motor 1208 is controlled by a Y toner replenisher 1204. When the toner in the developing device 1416 becomes less than a predetermined amount, the Y toner replenisher 1204 drives the motor 1208 in accordance with an instruction from the CPU 105, to thereby control replenishing the developing device 1416 with toner.

In the same manner, a toner bottle is attached to each of developing devices 1417, 1418, and 1419, which are used for forming images of the other colors. Rotation of the toner bottles of the respective colors is controlled by motors 1209, 1210, and 1211. An operation of the motor 1209 is controlled by an M toner replenisher 1205. An operation of the motor 1210 is controlled by a C toner replenisher 1206. An operation of the motor 1211 is controlled by a K toner replenisher 1207. The operations of the M toner replenisher 1205, the C toner replenisher 1206, and the K toner replenisher 1207, as well as that of the Y toner replenisher 1204, are also controlled by the CPU 105.

### Image Density Unevenness Correction

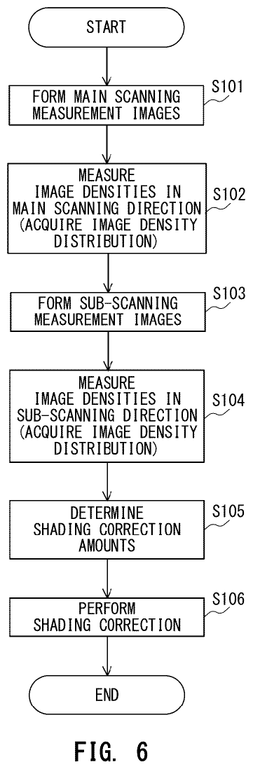

FIG. 6 is a flow chart for illustrating image density unevenness correction processing to be performed by the image forming apparatus 100 described above. In the following description, the image density unevenness correction may be referred to as “shading correction.” The shading correction is performed by the CPU 105 executing the computer program. For example, the shading correction is executed by the job control processor 201 or another functional block.

The CPU 105 controls the printer engine 102 by the printing processor 207 and the like to form, on a sheet, main scanning measurement images for measuring image densities in the main scanning direction (Step S101). The main scanning measurement image functions as a first detection image that is used for detecting densities of images formed at a plurality of different positions on the photosensitive drum 1402 in an axial direction of a rotation axis of the photosensitive drum 1402. The main scanning measurement image is described later in detail. The CPU 105 displays, on a screen of the operation unit 110, a message that prompts for reading of the main scanning measurement images using the reader 101. When a user inputs an instruction to start reading, the reader 101 transmits read data A, which is reading results (read image) of the main scanning measurement images, to the CPU 105. The measurement image may be read by an in-line sensor (not shown) provided on a downstream side of the fixing device 1414 in a conveyance direction in which the sheet is conveyed, instead of being read by the reader 101. In this case, the main scanning measurement images printed on the sheet are read by the in-line sensor while the sheet is being conveyed. Subsequently, in a case where the CPU 105 acquires the read data A of the main scanning measurement images, the CPU 105 measures the image densities of the main scanning measurement images based on the read data A (Step S102). In this manner, the CPU 105 acquires the image densities in the main scanning direction.

Subsequently, the CPU 105 controls the printer engine 102 by the printing processor 207 and the like to form, on a sheet, sub-scanning measurement images for measuring image densities in the sub-scanning direction (Step S103). The sub-scanning measurement image functions as a second detection image that is used for detecting densities of images formed at a plurality of different positions on the photosensitive drum 1402 in a rotation direction of the photosensitive drum 1402. The sub-scanning measurement image is described later in detail. The CPU 105 displays, on the screen of the operation unit 110, a message that prompts for reading of the sub-scanning measurement images using the reader 101. When the user inputs an instruction to start reading, the reader 101 reads the sub-scanning measurement images printed on the sheet, and transmits read data B, which is reading results (read image) of the sub-scanning measurement images, to the CPU 105. When the CPU 105 acquires the read data B, which is the reading results of the sub-scanning measurement images, from the reader 101, the CPU 105 measures the image densities of the sub-scanning measurement images based on the read data B (Step S104). In this manner, the CPU 105 acquires the image densities in the sub-scanning direction.

The CPU 105 acquires an image density distribution in the main scanning direction based on the image densities of the main scanning measurement images measured in the processing step of Step S102. The CPU 105 acquires an image density distribution in the sub-scanning direction based on the image densities of the sub-scanning measurement images measured in the processing step of Step S104. The CPU 105 determines, for each color component, such shading correction amounts (image density unevenness correction amounts) as to suppress the image density unevenness at respective positions (respective regions) in the main scanning direction and the sub-scanning direction based on the acquired image density distributions in both the directions (Step S105). A method of determining the image density unevenness correction amounts is described later in detail.

The CPU 105 performs the shading correction by setting the shading correction amounts for each color component in the printer engine 102 through the printer image processor 119 (Step S106). Known methods for the shading correction include a method of changing a modulation degree of pulse width modulation (PWM) of laser light depending on an exposure position based on the shading correction amount and a method of changing an intensity of laser light depending on an exposure position, but the present disclosure is not limited to those two methods.

In a case of the method of changing the modulation degree of the pulse width modulation of the laser light depending on the exposure position, the printer engine 102 stores the shading correction amounts for each color component in a memory (not shown) in the pulse width modulator 1203. This enables the pulse width modulator 1203 to change the modulation degree of the pulse width modulation of the laser light depending on the exposure position based on the shading correction amounts for each color component during image formation. As a result, the image density unevenness in the main scanning direction and the image density unevenness in the sub-scanning direction are corrected.

The image density unevenness in the main scanning direction is corrected by changing the modulation degree of the pulse width modulation of the laser light depending on a scanning position in the main scanning direction, and the image density unevenness in the sub-scanning direction is corrected by changing the modulation degree of the pulse width modulation of the laser light depending on a scanning position in the sub-scanning direction.

The scanning position in the sub-scanning direction corresponds to a rotation phase of each of the photosensitive drums 1401, 1402, 1403, and 1404. To that end, each of the photosensitive drums 1401, 1402, 1403, and 1404 is provided with, for example, a rotation phase detection sensor for detecting the rotation phase. Formation of the sub-scanning measurement image is started with a timing at which the phase detected by the rotation phase detection sensor becomes a reference phase being used as a reference. In this manner, the position of the sub-scanning measurement image on the sheet in the sub-scanning direction corresponds to the rotation phase of each of the photosensitive drums 1401, 1402, 1403, and 1404. The image densities are measured from the read data B of the sub-scanning measurement image in accordance with the rotation phases of each of the photosensitive drums 1401, 1402, 1403, and 1404. Therefore, the shading correction amount corresponding to the scanning position in the sub-scanning direction is determined by the image density distribution in the sub-scanning direction based on the measured image densities.

At a time of correcting the image density unevenness in the sub-scanning direction, the modulation degree of the pulse width modulation of the laser light is changed by an amount corresponding to the shading correction amount in accordance with the scanning position in the sub-scanning direction with the timing at which the phase detected by the rotation phase detection sensor becomes the reference phase being used as the reference. A timing of the correction may be predicted by a timer and the image density unevenness.

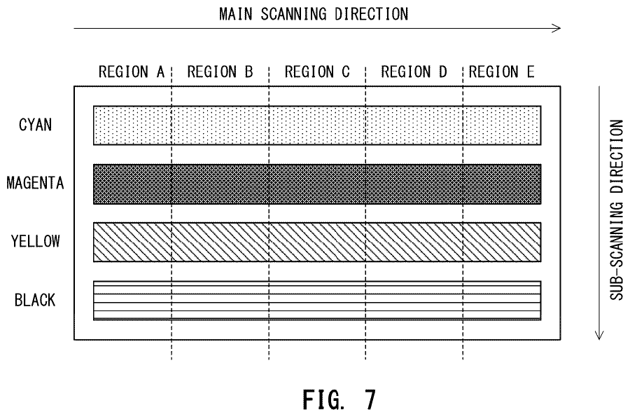

FIG. 7 is an explanatory view of the main scanning measurement images. In the first embodiment, the main scanning measurement images are printed on a sheet of an A4 size (210 mm×297 mm). The main scanning measurement image is a band-shaped image having a fixed width in the sub-scanning direction for each color component and having a longitudinal direction in the main scanning direction. Dimensions of the band-shaped image are 20 mm in the sub-scanning direction and 280 mm in the main scanning direction. The main scanning measurement images of the respective color components are arranged at a predetermined interval in the sub-scanning direction. The main scanning measurement image is formed based on a uniform image signal value, and ideally has a fixed image density. In the first embodiment, the image signal value is, for example, a value indicating an image density of 40%.

As an example, the main scanning measurement images illustrated in FIG. 7 are divided into five regions, that is, a region A to a region E, in the main scanning direction, and the image density of each region is measured. The CPU 105 acquires the image density for each region from the read data A transmitted from the reader 101. The division number of regions in the main scanning direction is not limited thereto. Further, a size of the sheet on which the main scanning measurement images are printed is not limited to the A4 size. The dimensions of the band-shaped image of each color are set to 20 mm×280 mm, but are not limited thereto.

The main scanning direction and the sub-scanning direction are the directions indicated by the arrows in the figure. As described above, the main scanning direction is the scanning direction of the laser light, and the sub-scanning direction is a direction intersecting the scanning direction of the laser light. The sub-scanning direction is also the same direction as the rotation direction of the intermediate transfer belt 1412 (conveyance direction of the toner image). The main scanning measurement images printed on the sheet not only have the image densities measured through use of the reader 101, but also may have the image densities measured through use of, for example, an external colorimeter.

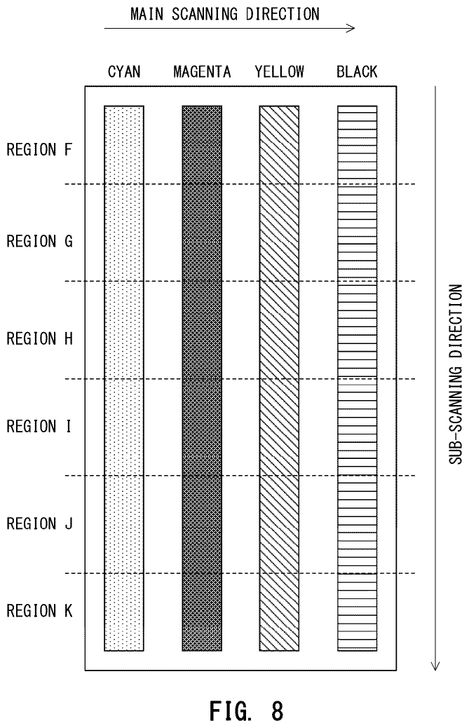

FIG. 8 is an explanatory view of the sub-scanning measurement images. In the first embodiment, the sub-scanning measurement images are printed on a sheet of an A3 size (297 mm×420 mm). The sub-scanning measurement image is a band-shaped image having a fixed width in the main scanning direction for each color component and having a longitudinal direction in the sub-scanning direction. The sub-scanning measurement images of the respective color components are arranged at a predetermined interval in the main scanning direction. The sub-scanning measurement image is formed based on a uniform image signal value, and ideally has a fixed image density. In the first embodiment, the image signal value is, for example, a value indicating the image density of 40%.

As an example, the sub-scanning measurement images illustrated in FIG. 8 are divided into six regions, that is, a region F to a region K, in the sub-scanning direction, and the image density of each region is measured. In this case, the rotation phase of the photosensitive drum 1403 at a time of forming the sub-scanning measurement image is adjusted so that a region on the photosensitive drum 1403 at a time of forming the region F of the cyan sub-scanning measurement image is the same region as a region on the photosensitive drum 1403 at a time of forming the cyan region A illustrated in FIG. 7. The rotation phase of the photosensitive drum 1402 at a time of forming the sub-scanning measurement image is adjusted so that a region on the photosensitive drum 1402 at a time of forming the region G of the magenta sub-scanning measurement image is the same region as a region on the photosensitive drum 1402 at a time of forming the magenta region B illustrated in FIG. 7. The rotation phase of the photosensitive drum 1401 at a time of forming the sub-scanning measurement image is adjusted so that a region on the photosensitive drum 1401 at a time of forming the region H of the yellow sub-scanning measurement image is the same region as a region on the photosensitive drum 1401 at a time of forming the yellow region C illustrated in FIG. 7. The rotation phase of the photosensitive drum 1404 at a time of forming the sub-scanning measurement image is adjusted so that a region on the photosensitive drum 1404 at a time of forming the region I of the black sub-scanning measurement image is the same region as a region on the photosensitive drum 1404 at a time of forming the black region D illustrated in FIG. 7. The CPU 105 obtains the image density for each region from the read data B of the reader 101. The division number of regions in the sub-scanning direction is not limited thereto. Further, the size of the sheet on which the sub-scanning measurement images are printed is not limited to the A3 size.

In a case of reading the sub-scanning measurement images, a length of the sheet in the sub-scanning direction may exceed a size of the reader 101. In this case, an automatic document feeder (ADF) (not shown) that can be attached to the reader 101 may be used to read the sub-scanning measurement images from the sheet that is automatically fed by the ADF.

### Determination of Shading Correction Amount

Processing for determining the shading correction amounts (image density unevenness correction amounts) in Step S105 of FIG. 6 is described below. That is, a method for the image density unevenness correction in the main scanning direction and the sub-scanning direction of the image forming apparatus 100 is described.

For the main scanning measurement images formed in the processing step of Step S101 of FIG. 6, the respective image densities of the region A to the region E are measured for each color component as described with reference to FIG. 7. The CPU 105 calculates, for each color component, an average value (average density) DSA of the image densities respectively measured for the region A to the region E.

For the sub-scanning measurement images formed in the processing step of Step S103 of FIG. 6, the respective image densities of the region F to the region K are measured for each color component as described with reference to FIG. 8. The CPU 105 calculates, for each color component, an average value (average density) DFA of the image densities respectively measured for the region F to the region K.

The CPU 105 calculates an average density DZA of the average density DSA in the main scanning direction and the average density DFA in the sub-scanning direction as DZA=(DSA+DFA)/2. The CPU 105 determines the average density DZA as target data regarding a target density. The CPU 105 calculates a difference (density difference) ΔDens between the average density DZA and each of the image densities of the region A to the region E in the main scanning direction and the region F to the region K in the sub-scanning direction. In this case, the density difference from the cyan region A is equal to the density difference from the cyan region F. The density difference from the magenta region B is equal to the density difference from the magenta region G. The density difference from the yellow region C is equal to the density difference from the yellow region H. The density difference from the black region Dis equal to the density difference from the black region I.

In the image forming apparatus 100 according to the first embodiment, even when the main scanning measurement images and the sub-scanning measurement images are different, the density differences ΔDens are calculated from the average density DZA. The average density DZA is set as a correction target (target density). This can eliminate deterioration in correction accuracy caused by a difference between the average density of the image densities in the main scanning direction and the average density of the image densities in the sub-scanning direction. The image forming apparatus 100 determines the shading correction amount for each of the region A to the region E in the main scanning direction and the shading correction amount for each of the region F to the region K in the sub-scanning direction so as to correct the image density unevenness in the main scanning direction.

The CPU 105 calculates the shading correction amount for each region based on the density difference ΔDens. As described above, the density difference from the cyan region A is equal to the density difference from the cyan region F. The density difference from the magenta region B is equal to the density difference from the magenta region G. The density difference from the yellow region C is equal to the density difference from the yellow region H. The density difference from the black region D is equal to the density difference from the black region I. The shading correction amount for each region is calculated by Expression 1.

(shading correction amount)=ΔDens×(correction coefficient N) (Expression 1)

The correction coefficient N represents a coefficient for determining a change amount of a PWM modulation amount of the laser light (or change amount of the intensity of the laser light) relative to the density difference ΔDens. It is indicated that the modulation level is changed by, for example, “1” in a case where the correction coefficient N is “100” and the density difference ΔDens is “0.01”. In the first embodiment, the correction coefficient N is set to “200”, but the correction coefficient N is not limited thereto. In this case, a calculation result of the right-hand side of Expression 1 is rounded off to the nearest integer to calculate the shading correction amount, but the present disclosure is not limited thereto.

In the first embodiment, the shading correction amounts are calculated based on the average values of the respective image densities of the region A to the region K. In addition to the average value, the shading correction amount may be obtained based on an intermediate value or a value obtained by other statistical processing. It is important to determine the shading correction amount with the target density in the main scanning direction and the target density in the sub-scanning direction being matched with each other. In the first embodiment, the average density DZA is used as the target density (correction target). The CPU 105 can correct the image density unevenness in the main scanning direction and the image density unevenness in the sub-scanning direction by adjusting the laser light for each exposure position based on the shading correction amount determined in the above-mentioned manner.

The CPU 105 suppresses density unevenness of an image to be formed on the photosensitive drum 1402 in the sub-scanning direction based on the results of reading the main scanning measurement images by the reader 101, the results of reading the sub-scanning measurement images by the reader 101, and the average density DZA. The CPU 105 also suppresses density unevenness of an image to be formed on the photosensitive drum 1402 in the main scanning direction based on the results of reading the main scanning measurement images by the reader 101, the results of reading the sub-scanning measurement images by the reader 101, and the average density DZA.

In the above description, a configuration in which the main scanning measurement images and the sub-scanning measurement images that are printed on the sheets are read by the reader 101 has been described, but a configuration in which each measurement image is read by the image density sensor 400 may be employed. In this case, the measurement images for each direction are read by the image density sensor 400 while being borne on the intermediate transfer belt 1412. The image density unevenness correction based on the reading results is the same as in the case of using the sheets. With such a configuration, it is possible to measure the image density unevenness in the sub-scanning direction irrespective of the size of the sheet.

An effect exhibited by the image density unevenness correction in the first embodiment described above is described. As a comparative example, a case in which the image density unevenness correction in the main scanning direction and the image density unevenness correction in the sub-scanning direction are separately performed is described. In this case, it is assumed that the image density unevenness is a difference between a maximum value and a minimum value of the image density value.

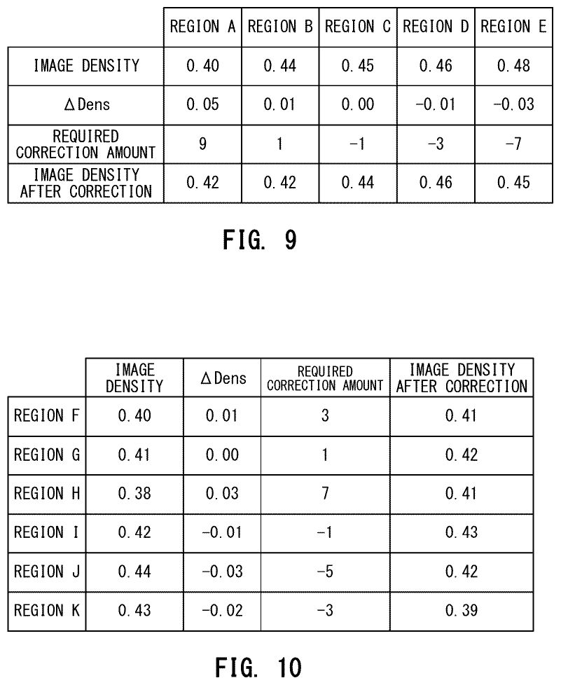

When the image density unevenness correction in the main scanning direction and the image density unevenness correction in the sub-scanning direction are separately performed, for example, the image density unevenness correction in the sub-scanning direction is performed after the image density unevenness correction in the main scanning direction is performed. FIG. 9 is an explanatory table for showing image densities in the main scanning direction after the image density unevenness correction. FIG. 10 is an explanatory table for showing image densities in the sub-scanning direction after the image density unevenness correction. The average density of the image densities in the main scanning direction before the correction is “0.45”, and the difference in image density in the main scanning direction after the correction is “0.04” from the maximum value and the minimum value. The average density of the image densities in the sub-scanning direction before the correction is “0.41”, and the difference in image density in the sub-scanning direction after the correction is “0.04” from the maximum value and the minimum value. The target density is “0.45” in the main scanning direction and “0.41” in the sub-scanning direction, thereby assuming different values.

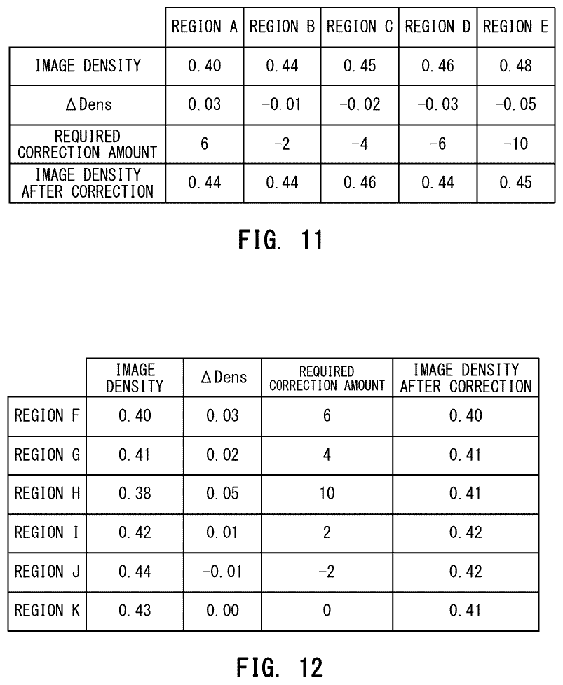

FIG. 11 is an explanatory table for showing image densities in the main scanning direction after the image density unevenness correction in the first embodiment. FIG. 12 is an explanatory table for showing image densities in the sub-scanning direction after the image density unevenness correction in the first embodiment. The difference in image density in the main scanning direction after the correction is “0.02” from the maximum value and the minimum value. The difference in image density in the sub-scanning direction after the correction is “0.02” from the maximum value and the minimum value. In comparison to FIG. 9 and FIG. 10, in FIG. 11 and FIG. 12, the differences in image density after the correction are smaller in both the main scanning direction and the sub-scanning direction.

In the first embodiment, the respective target densities in the main scanning direction and the sub-scanning direction are not separately set for the respective directions, but are set in common based on the respective average densities. Therefore, the image density unevenness correction in the first embodiment results in a smaller difference in image density after the correction than when image density unevenness correction is separately performed for the respective directions. As described above, the shading correction amounts are determined based on a common target density for the main scanning direction and the sub-scanning direction, to thereby perform the image density unevenness correction with high accuracy in both the directions of the main scanning direction and the sub-scanning direction. In other words, it is possible to achieve correction of the image density unevenness in different directions with high accuracy by performing the image density unevenness correction in the first embodiment.

### Second Embodiment

The image forming apparatus 100 according to a second embodiment of the present disclosure has the same configuration as that of the first embodiment, and hence description of the configuration is omitted. In the first embodiment, both the image density unevenness in the main scanning direction and the image density unevenness in the sub-scanning direction are detected. In other words, the main scanning measurement images and the sub-scanning measurement images are printed on different sheets. For that reason, a plurality of sheets are required for the image density unevenness correction processing. In addition, the image density unevenness correction processing requires much time due to the printing on a plurality of sheets.

In the second embodiment, during the image density unevenness correction processing, any one of the detection of the image density unevenness in the main scanning direction and the detection of the image density unevenness in the sub-scanning direction is performed, and detection results acquired in the past are used as results of the other detection of the image density unevenness. In such processing, the number of sheets used in the image density unevenness correction processing can be reduced, and a processing time thereof can be shortened.

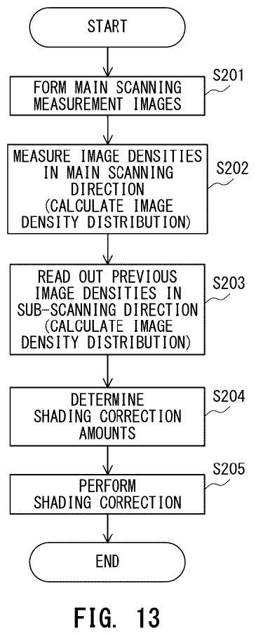

FIG. 13 is a flow chart for illustrating the image density unevenness correction processing in the second embodiment. A case in which the image density unevenness in the main scanning direction is detected by the same processing as in the first embodiment and the previous detection results of the image densities are used for the image density unevenness in the sub-scanning direction is described below, but the reverse case is also possible. The previous detection results of the image densities are assumed to be stored in the storage 108 in the second embodiment, but may be stored in an external device such as a server.

The CPU 105 measures the image densities of the main scanning measurement images by the same processing steps as those of Step S101 and Step S102 of FIG. 6, and acquires the image density distribution in the main scanning direction (Step S201 and Step S202). The CPU 105 reads out the previous detection results of the image densities in the sub-scanning direction from the storage 108, and acquires the image density distribution in the sub-scanning direction (Step S203). The CPU 105 determines the shading correction amounts by the same processing steps as those of Step S105 and Step S106 of FIG. 6, and performs shading correction (Step S204 and Step S205). The storage 108 may store the image density distribution in the sub-scanning direction obtained from the previous detection results of the image densities in the sub-scanning direction. In this case, the CPU 105 reads the previous image density distribution in the sub-scanning direction from the storage 108, and advances the process to Step S204.

An example in which the previous detection results of the image densities are used has been described above, but the present disclosure is not limited to the previous detection results, and the detection results obtained two times before may be used. Further, information to be used may be a statistical value of the past detection results (for example, an average value of the results obtained one time before and two times before).

Even in the above-mentioned image forming apparatus 100 according to the second embodiment, the laser light is corrected in accordance with the shading correction amounts in the same manner as in the first embodiment. Thus, the image density unevenness is corrected in the same manner as in the first embodiment.

### Third Embodiment

The image forming apparatus 100 according to a third embodiment of the present disclosure has the same configuration as that of the first embodiment, and hence description of the configuration is omitted. In the third embodiment, the image density unevenness is measured based on surface potentials of the photosensitive drums 1401, 1402, 1403, and 1404 in place of measurement results of measurement images printed on each sheet. For example, the image density unevenness is measured based on the surface potentials exhibited after the toner images of the measurement images are formed on the surfaces of the photosensitive drums 1401, 1402, 1403, and 1404. To that end, potential sensors are provided around the photosensitive drums 1401, 1402, 1403, and 1404. The photosensitive drums 1401, 1402, 1403, and 1404 each function as an image bearing member such as the intermediate transfer belt 1412 and the sheet.

In this case, average values of potentials of the photosensitive drums 1401, 1402, 1403, and 1404 in the main scanning direction and the sub-scanning direction are averaged to determine an average potential serving as the target density. A potential difference ΔV is calculated instead of the density difference ΔDens from the average potential and each of potentials of respective regions in the main scanning direction and potentials of respective regions in the sub-scanning direction. The potential difference AV is a difference between the average potential and each of the surface potentials of the respective regions of the toner images of the measurement images formed on the photosensitive drums 1401, 1402, 1403, and 1404. The shading correction amounts are each calculated by multiplying the potential difference AV by the correction coefficient N. The laser light is corrected in accordance with the shading correction amounts, to thereby correct the image density unevenness. Further, as in the second embodiment, potentials measured in the past may be used for any one of the main scanning direction and the sub-scanning direction to perform the image density unevenness correction processing.

### Fourth Embodiment

The image forming apparatus 100 according to a fourth embodiment of the present disclosure has the same configuration as that of the first embodiment, and hence description of the configuration is omitted. In the first embodiment, information on the image density in the sub-scanning direction actually measured from the yellow main scanning measurement image is only for the region H in the sub-scanning direction. Information on the image density in the sub-scanning direction actually measured from each of the main scanning measurement images of magenta, cyan, and black, which are colors other than yellow, is also only for one region in the sub-scanning direction. Then, the density unevenness (distribution) in the sub-scanning direction of each of the region A to the region E in the main scanning direction is determined by offsetting the actually measured density of each of the regions in which the sub-scanning measurement images are formed in the main scanning direction by the density difference of each of the region A to the region E of the main scanning measurement images formed in one region in the sub-scanning direction. Therefore, in a case where the density distributions in the sub-scanning direction of the region A to the region E that differ in the main scanning direction are different from each other, the density unevenness in the sub-scanning direction cannot be suppressed with high accuracy.

In density unevenness correction in the fourth embodiment, a plurality of measurement images of each color are formed in the main scanning direction, and image densities of a plurality of different regions are detected in both the main scanning direction and the sub-scanning direction. Thus, it is possible to suppress the density unevenness with higher accuracy than in the density unevenness correction in the first embodiment.

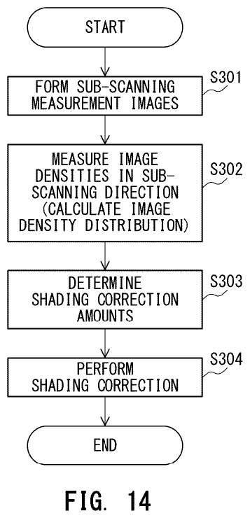

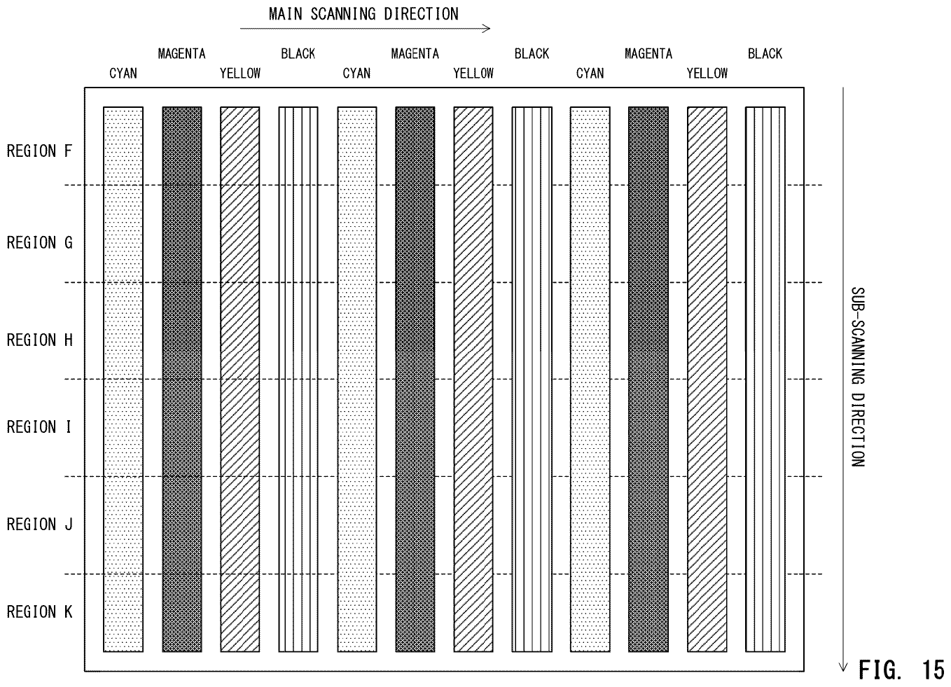

FIG. 14 is a flow chart for illustrating image density unevenness correction processing in the sub-scanning direction to be performed by the image forming apparatus 100 according to the fourth embodiment. In the following description, the image density unevenness correction in the sub-scanning direction is referred to as “sub-scanning shading correction.” The sub-scanning shading correction is performed by the CPU 105 executing the computer program.

The CPU 105 controls the printer engine 102 by the printing processor 207 and the like to form sub-scanning measurement images (FIG. 15) on a sheet (Step S301). The CPU 105 displays, on the screen of the operation unit 110, the message that prompts for reading of the sub-scanning measurement images using the reader 101. When the user inputs the instruction to start reading, the reader 101 transmits the read data B, which is the reading results (read image) of the sub-scanning measurement images, to the CPU 105. The sub-scanning measurement image may be read by the in-line sensor (not shown) provided on a downstream side of the fixing device 1414 in the conveyance direction in which the sheet is conveyed, instead of being read by the reader 101. In this case, the sub-scanning measurement images printed on the sheet are read by the in-line sensor while the sheet is being conveyed.

Subsequently, in a case where the CPU 105 acquires the read data B of the sub-scanning measurement images, the CPU 105 measures the image densities of the sub-scanning measurement images based on the read data B (Step S302). In this manner, the CPU 105 acquires image density distributions in the sub-scanning direction at a plurality of different positions in the main scanning direction.

The CPU 105 determines, for each color component, such shading correction amounts (image density unevenness correction amounts) as to suppress the image density unevenness at respective positions (respective regions) in the sub-scanning direction based on the image density distributions in the sub-scanning direction at the plurality of different positions in the main scanning direction (Step S303). The method of determining the image density unevenness correction amounts is described later in detail.

The CPU 105 performs the shading correction by setting the shading correction amounts for each color component in the printer engine 102 through the printer image processor 119 (Step S304). Known methods for the shading correction include the method of changing the modulation degree of the pulse width modulation (PWM) of laser light depending on an exposure position based on the shading correction amount and the method of changing the intensity of laser light depending on an exposure position, but the present disclosure is not limited to those two methods.

The image density unevenness in the sub-scanning direction is corrected by changing the modulation degree of the pulse width modulation of the laser light depending on the scanning position in the sub-scanning direction. At the time of correcting the image density unevenness in the sub-scanning direction, the modulation degree of the pulse width modulation of the laser light is changed by the amount corresponding to the shading correction amounts in accordance with the scanning position in the sub-scanning direction with the timing at which the phase detected by the rotation phase detection sensor becomes the reference phase being used as the reference. The timing of the correction may be predicted by the timer and the image density unevenness.

FIG. 15 is an explanatory view of the sub-scanning measurement images. In the fourth embodiment, the sub-scanning measurement images are printed on a sheet of the A3 size (297 mm×420 mm). The sub-scanning measurement images have, for each color component, three band-shaped images having a longitudinal direction in the sub-scanning direction. The sub-scanning measurement images have, for each color component, a fixed width in the main scanning direction. The respective band-shaped images are arranged at a predetermined interval in the main scanning direction. The sheet on which a plurality of band-shaped images have been formed has a region in which no image of any color is formed between band-shaped images of the same color in the main scanning direction. The three yellow band-shaped images are formed with the same image signal value, and ideally, all image densities thereof are the same density. The same holds true also for the magenta, cyan, and black band-shaped images. In the fourth embodiment, the image signal value is set to indicate, for example, the image density of 40% irrespective of the color. The image signal value may differ for each color, and the ideal image density may differ for each color. For example, in FIG. 15, a plurality of band-shaped images of a first color on the sheet are a first measurement image and a second measurement image, and band-shaped images of a second color different from the first color on the sheet are a third measurement image and a fourth measurement image. In this case, in a case where the first color is, for example, cyan, the second color is a color other than cyan, that is, yellow, magenta, or black, and in a case where the first color is, for example, yellow, the second color is a color other than yellow, that is, cyan, magenta, or black.

The sub-scanning measurement images illustrated in FIG. 15 is divided into six regions, that is, the region F to the region K in the sub-scanning direction as an example, and the image density of each region is measured. The CPU 105 acquires the image density for each region from the read data B transmitted from the reader 101. The division number of regions in the sub-scanning direction is not limited thereto. Further, the size of the sheet on which the sub-scanning measurement images are printed is not limited to the A3 size.

In the case of reading the sub-scanning measurement images, the length of the sheet in the sub-scanning direction may exceed the size of the reader 101. In this case, the reader 101 may use the ADF (not shown) that can be attached to the reader 101 to read the sub-scanning measurement images from the sheet that is automatically fed by the ADF.

### Determination of Shading Correction Amount

Processing for determining the shading correction amounts (image density unevenness correction amounts) in Step S304 of FIG. 14 is described below. A method for the image density unevenness correction in the sub-scanning direction of the image forming apparatus 100 is described.

As described with reference to FIG. 15, the sub-scanning measurement images formed in the processing step of Step S301 of FIG. 14 have the respective image densities of the region F to the region K measured three times for each color component. The CPU 105 acquires the respective densities of the region F to the region K of the three band-shaped images. The CPU 105 acquires, from the first band-shaped image, a density DF1 of the region F, a density DGI of the region G, a density DH1 of the region H, a density DI1 of the region I, a density DJI of the region J, and a density DK1 of the region K. The CPU 105 acquires, from the second band-shaped image, a density DF2 of the region F, a density DG2 of the region G, a density DH2 of the region H, a density DI2 of the region I, a density DJ2 of the region J, and a density DK2 of the region K. The CPU 105 acquires, from the third band-shaped image, a density DF3 of the region F, a density DG3 of the region G, a density DH3 of the region H, a density DI3 of the region I, a density DJ3 of the region J, and a density DK3 of the region K.

The CPU 105 calculates, for each color component, an average density (average value) DFA′ of the respective densities respectively measured for the region F to the region K of the band-shaped images. The sub-scanning measurement images of each color component are three band-shaped images formed in the plurality of different regions in the main scanning direction. Therefore, the average density (average value) DFA′ of the respective densities of the region F to the region K of the three band-shaped images corresponds to the average density DZA described in the first embodiment. Subsequently, the CPU 105 calculates average densities DFave to DKave of the region F to the region K in the sub-scanning direction from the densities of the region F to the region K of the three band-shaped images, respectively. For example, the average density DFave of the region F is an average value of the density DF1, the density DF2, and the density DF3.

Then, the CPU 105 calculates a difference (density difference) ΔDens between the average density DFA′ and each of the average densities DFave to DKave of the region F to the region K in the sub-scanning direction. The CPU 105 calculates the shading correction amount for each of the region F to the region K in the sub-scanning direction based on the density difference ΔDens. Subsequently, the CPU 105 adjusts the intensity of the laser light for each of the exposure positions (region F to region K in the sub-scanning direction) based on the shading correction amount determined in the above-mentioned manner, to thereby correct the image density unevenness in the sub-scanning direction.

In the fourth embodiment, the shading correction amounts for the sub-scanning direction are calculated based on the average values using the band-shaped images formed at a plurality of positions in the main scanning direction. The image forming apparatus 100 according to the fourth embodiment also determines the shading correction amount with the target density in the main scanning direction and the target density in the sub-scanning direction being matched with each other. The CPU 105 can correct the image density unevenness in the main scanning direction and the image density unevenness in the sub-scanning direction by adjusting the laser light for each exposure position based on the shading correction amount determined in the above-mentioned manner.

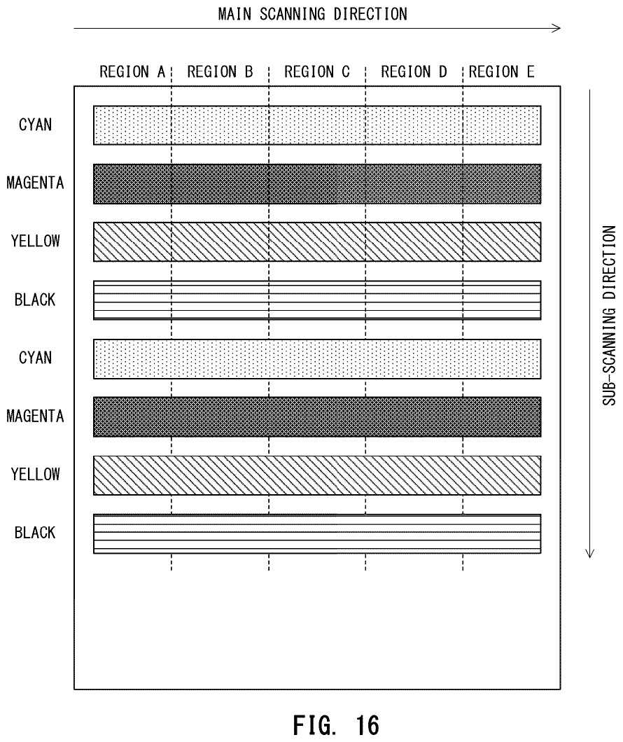

Further, FIG. 16 is an explanatory view of the main scanning measurement images. The main scanning measurement images are printed on a sheet of the A4 size (210 mm×297 mm). The main scanning measurement images have, for each color component, two band-shaped images having a longitudinal direction in the main scanning direction. The main scanning measurement images have, for each color component, a fixed width in the main scanning direction. The respective band-shaped images are arranged at a predetermined interval in the sub-scanning direction. The two yellow band-shaped images are formed with the same image signal value, and ideally, both image densities thereof are the same density. The same holds true also for the magenta, cyan, and black band-shaped images. In the fourth embodiment, the image signal value is set to indicate, for example, the image density of 40% irrespective of the color. The image signal value may differ for each color, and the ideal image density may differ for each color.

Even in a case of using the main scanning measurement images illustrated in FIG. 16 is used, the shading correction amounts for the main scanning direction are calculated based on the average values using the band-shaped images formed at a plurality of positions in the sub-scanning direction. This image forming apparatus 100 also determines the shading correction amount with the target density in the main scanning direction and the target density in the sub-scanning direction being matched with each other. The CPU 105 can correct the image density unevenness in the main scanning direction and the image density unevenness in the sub-scanning direction by adjusting the laser light for each exposure position based on the shading correction amount determined in the above-mentioned manner.

According to the first to fourth embodiments described above, the density unevenness of an image that is formed by the image forming apparatus can be suppressed with high accuracy. In the configurations of the first to fourth embodiments, the intensity (or modulation amount) of the laser light is adjusted in order to correct the density unevenness in the sub-scanning direction. However, the parameter for correcting the density unevenness in the sub-scanning direction is not limited to the intensity (or modulation amount) of the laser light. For example, the charging bias voltage to be applied to the charge roller 1400 may be adjusted in synchronization with the rotation phase of the photosensitive drum 1401 to correct the density unevenness in the sub-scanning direction. In another example, the developing bias voltage to be applied to the developing sleeve 1422 may be adjusted in synchronization with the rotation phase of the photosensitive drum 1401 to correct the density unevenness in the sub-scanning direction. In another case, both the charging bias voltage and the developing bias voltage may be adjusted in synchronization with the rotation phase of the photosensitive drum 1401 to correct the density unevenness in the sub-scanning direction. The intensity (or modulation amount) of the laser light, the charging bias voltage, and the developing bias voltage are examples of image forming conditions for adjusting the densities of an image to be formed at a plurality of different positions on the photosensitive drum 1402 in the sub-scanning direction.

The structures and details of various types of data in the first to fourth embodiments described above are not limited to those described therein, and it should be understood that the data may be formed in various structures and details depending on the application and the purpose. The present disclosure can be embodied as, for example, a system, an apparatus, a method, a program, or a storage medium. Specifically, the present disclosure may be applied to a system formed of a plurality of pieces of equipment, or may be applied to an apparatus formed of a single piece of equipment. The present disclosure also includes all configurations that combine the embodiments described above.

The image forming apparatus 100 has been described above as having a configuration capable of forming a color image, but the present disclosure is also effective for a monochrome printer that forms a monochrome image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2024-006350, filed Jan. 18, 2024 and No. 2024-192996, filed Nov. 1, 2024, which are hereby incorporated by reference herein in their entirety.

What is claimed is:

1. An image forming apparatus for forming an image on a sheet, the image forming apparatus comprising:
an image forming unit configured to form an image on a photosensitive member with the photosensitive member rotating, and transfer the image formed on the photosensitive member onto the sheet to form the image on the sheet;
a reading unit configured to read a measurement image formed on the sheet by the image forming unit, the measurement image including:
a first detection image for detecting density at positions different in an axial direction of a rotation axis of the photosensitive member of an image to be formed on the photosensitive member; and
a second detection image for detecting density at positions different in a rotation direction of the photosensitive member of an image to be formed on the photosensitive member; and
a controller configured to:
determine target data based on reading results of the first detection image read by the reading unit and reading results of the second detection image read by the reading unit; and
suppress the density unevenness of the image to be formed on the photosensitive member in the rotation direction of the photosensitive member, based on the reading results of the first detection image read by the reading unit, the reading results of the second detection image read by the reading unit, and the target data.

2. The image forming apparatus according to claim 1,
wherein the image forming unit is configured to be controlled based on an image forming condition for adjusting the densities of the image to be formed at a plurality of different positions on the photosensitive member in the rotation direction of the photosensitive member, and
wherein the controller is configured to generate the image forming condition based on the reading results of the first detection image read by the reading unit, the reading results of the second detection image read by the reading unit, and the target data.

3. The image forming apparatus according to claim 2,
wherein the image forming unit includes:
a charging member configured to charge the photosensitive member;
a light source configured to expose the photosensitive member charged by the charging member to form an electrostatic latent image on the photosensitive member; and
a developing sleeve configured to develop the electrostatic latent image on the photosensitive member, and
wherein the image forming condition is an intensity of light from the light source.

4. The image forming apparatus according to claim 2,
wherein the image forming unit includes:
a charging member configured to charge the photosensitive member based on a charging bias voltage;
a light source configured to expose the photosensitive member charged by the charging member to form an electrostatic latent image on the photosensitive member; and
a developing sleeve configured to develop the electrostatic latent image on the photosensitive member, and
wherein the image forming condition is the charging bias voltage.

5. The image forming apparatus according to claim 2,
wherein the image forming unit includes:
a charging member configured to charge the photosensitive member;
a light source configured to expose the photosensitive member charged by the charging member to form an electrostatic latent image on the photosensitive member; and
a developing sleeve configured to develop the electrostatic latent image on the photosensitive member based on a developing bias voltage, and
wherein the image forming condition is the developing bias voltage.

6. An image forming apparatus for forming an image on a sheet, the image forming apparatus comprising:
an image forming unit configured to form an image on a photosensitive member with the photosensitive member rotating, and transfer the image formed on the photosensitive member onto the sheet;
a reading unit configured to read a measurement image formed on the sheet by the image forming unit, the measurement image including:
a first detection image for detecting densities of images at different positions in an axial direction of a rotation axis of the photosensitive member; and
a second detection image for detecting densities of images at different positions in a rotation direction of the photosensitive member; and
a controller configured to:
determine target data based on reading results of the first detection image read by the reading unit and reading results of the second detection image read by the reading unit; and
suppress the density unevenness of the image to be formed on the photosensitive member in the axial direction, based on the reading results of the first detection image read by the reading unit, the reading results of the second detection image read by the reading unit, and the target data.

7. The image forming apparatus according to claim 6,
wherein the image forming unit is configured to be controlled based on an image forming condition for adjusting the densities of the image to be formed at a plurality of different positions on the photosensitive member in the axial direction, and
wherein the controller is configured to generate the image forming condition based on the reading results of the first detection image read by the reading unit, the reading results of the second detection image read by the reading unit, and the target data.

8. The image forming apparatus according to claim 7,
wherein the image forming unit includes:
a charging member configured to charge the photosensitive member;
a light source configured to expose the photosensitive member charged by the charging member in order to form an electrostatic latent image on the photosensitive member; and
a developing sleeve configured to develop the electrostatic latent image on the photosensitive member, and
wherein the image forming condition is an intensity of light from the light source.

9. An image forming apparatus for forming an image on a sheet, the image forming apparatus comprising:
an image forming unit configured to form an image of a first color on a first photosensitive member with the first photosensitive member rotating;
a reading unit configured to read a plurality of measurement images on the sheet which have been formed by the image forming unit, the plurality of measurement images including:
a first measurement image for detecting density at positions different in a rotation direction of an image to be formed on the first photosensitive member; and
a second measurement image for detecting density at positions different in the rotation direction of an image to be formed on the first photosensitive member,
wherein the sheet on which the plurality of measurement images are formed has a region where an image of the first color is not formed between the first measurement image and the second measurement image in an axial direction of a rotation axis of the first photosensitive member; and
a controller,
determine target data based on reading results of the first measurement image read by the reading unit and reading results of the second measurement image read by the reading unit; and
suppress density unevenness of an image of the first color to be formed on the first photosensitive member in the rotation direction of the first photosensitive member, based on the reading results of the first measurement image read by the reading unit, the reading results of the second measurement image read by the reading unit, and the target data.

10. The image forming apparatus according to claim 9,
wherein the image forming unit is configured to form an image of a second color different from the first color on a second photosensitive member with the second photosensitive member rotating,
wherein the plurality of measurement images further include:
a third measurement image for detecting density at positions different in a rotation direction of an image to be formed on the second photosensitive member; and
a fourth measurement image for detecting density at positions different in the rotation direction of an image to be formed on the second photosensitive member,
wherein the sheet on which the plurality of measurement images are formed has the third measurement image in the region between the first measurement image and the second measurement image in the axial direction, and
wherein the sheet on which the plurality of measurement images are formed has the second measurement image between the third measurement image and the fourth measurement image in the axial direction.

11. The image forming apparatus according to claim 9,
wherein the image forming unit is configured to be controlled based on an image forming condition for adjusting the densities of the image of the first color to be formed at a plurality of different positions on the first photosensitive member in the rotation direction of the first photosensitive member, and
wherein the controller is configured to generate the image forming condition based on the reading results of the first measurement image read by the reading unit, the reading results of the second measurement image read by the reading unit, and the target data.

12. The image forming apparatus according to claim 11,
wherein the image forming unit includes:
a charging member configured to charge the first photosensitive member;
a light source configured to expose the first photosensitive member charged by the charging member in order to form an electrostatic latent image on the first photosensitive member; and
a developing sleeve configured to develop the electrostatic latent image on the first photosensitive member, and
wherein the image forming condition is an intensity of light from the light source.

13. The image forming apparatus according to claim 11,
wherein the image forming unit includes:
a charging member configured to charge the first photosensitive member based on a charging bias voltage;
a light source configured to expose the first photosensitive member charged by the charging member in order to form an electrostatic latent image on the first photosensitive member; and
a developing sleeve configured to develop the electrostatic latent image on the first photosensitive member, and
wherein the image forming condition is the charging bias voltage.

14. The image forming apparatus according to claim 11,
wherein the image forming unit includes:
a charging member configured to charge the first photosensitive member;
a light source configured to expose the first photosensitive member charged by the charging member in order to form an electrostatic latent image on the first photosensitive member; and
a developing sleeve configured to develop the electrostatic latent image on the first photosensitive member based on a developing bias voltage, and
wherein the image forming condition is the developing bias voltage.

15. The image forming apparatus according to claim 11,
wherein the controller is configured to determine density data regarding densities at each of the plurality of positions in the rotation direction of the first photosensitive member based on reading results of the first measurement image read by the reading unit and reading results of the second measurement image read by the reading unit, and
wherein the controller is configured to generate the image forming condition based on the density data and the target data.
